(19) United States
(12) Patent Application Publication
(10) Pub. No.: US 2021/0282360 A1
(43) Pub. Date: Sep. 16, 2021

(54) Litter Box

(71) Applicant: Spencer Jackson, Vero Beach, FL (US)

(72) Inventor: Spencer Jackson, Vero Beach, FL (US)

(21) Appl. No.: 16/922,313

(22) Filed: Jul. 7, 2020

Related U.S. Application Data
(60) Provisional application No. 62/988,809, filed on Mar. 12, 2020.

(51) Int. Cl. A01K 1/01; A01K 1/035

(52) U.S. Cl. CPC A01K 1/0107; A01K 1/035

(57) ABSTRACT

This present application discloses a litter box comprised of a generally rectangular or square box-style enclosure featuring a ventilation system and an adjustable opening, sized for only cats to pass through, and that prevents dogs and other household pets from inadvertently accessing the litter box and making a mess. The litter box also offers privacy to a cat while maintaining proper light and ventilation to keep the cat comfortable while using the bathroom, and ensures that foul odors remain within the litter box until the litter box is cleaned. The litter box is further comprised of a top with a handle and hook and eye clamps to lock the top, a name placard, carpeting, and wood trim lines along the entrance, corners, and windows.

### CROSS-REFERENCE TO RELATED APPLICATION

The present application claims priority to, and the benefit of, U.S. Provisional Application No. 62/988,809, which was filed on Mar. 12, 2020 and is incorporated herein by reference in its entirety.

### BACKGROUND

The present invention relates generally to the field of litter boxes for pets, such as cats and, more particularly, to a litter box with a quadrate or box-style enclosure that features a window ventilation system and an adjustable opening sized only for cats. As used herein, the term “litter box” refers to a box or pan filled with an absorbent, granular material or litter into which a cat defecates and the litter functions to absorb moisture and form clumps for identification and easy removal. The term “box-style enclosure” refers to a square or rectangular enclosure or box that features a window ventilation system, a lid, and an adjustable opening, sized only for cats to pass through. Accordingly, the present specification makes specific reference to the assembly described in the invention and it is to be appreciated that aspects of the present invention are also equally applicable to other similar applications, devices, and methods of manufacture.

By way of background, litter boxes are a necessity for individuals who own cats, particularly those that remain indoors and do not venture outside. Providing a feline animal with a sanitary and recognizable inside space for eliminating bodily waste, litter boxes are an important addition in any home having a cat. Litter boxes are indoor solid and liquid waste collection boxes that are commonly used by cats. Domesticated cats may enter the litter box to relieve themselves of waste, without having to go outside. Because cats naturally excrete in material like soft soil, sand and the like which permits easy covering, concealment or burial of the waste, the litter box is filled with a litter box filler commonly made of a loose granular material that absorbs moisture and odor. Litter boxes are generally constructed with a base that may be integrally molded to surrounding walls that retain the filler within the box or may be removably detachable from the surrounding walls so that the litter pan can be easily removed.

When a cat evacuates or eliminates waste in the litter box, the cat tends to scratch and shift the litter to cover or hide the eliminated waste, which can cause litter to spray out of the cat litter box. Further, litter particles get stuck to the cat's paws and are thus carried out of the litter box by the cat into the room and surrounding area, resulting in the need for frequent cleaning of the room in addition to raising other sanitary concerns.

A common problem with the conventional design is that other animals, namely dogs, can access the cat litter box. Unfortunately, dogs are naturally drawn to and may even enjoy the cat excrement which can lead to numerous health problems. Specifically, canine coprophagia may cause intestinal blockage, and promote the transmission of parasites present in cat feces such as a Toxoplasma gondii. In most cases, infants and small children of the home may touch or get in contact with the litter box inadvertently, such as through litter tracked through the house by the cat or the dog having recently visited the litter pan, thus causing a dangerous health issue for the children. Thus, it becomes necessary for the parents or another responsible individual of the home to constantly check the small children and other pets of the house to stop them from going close to the cat litter box and to look for litter debris that may have gotten outside of the litter box.

Conventional litter boxes are typically unattractive and an eyesore when stored in certain rooms of a home and thus normally are hidden away in laundry rooms, closets or other areas which are not regularly viewed by the inhabitants or guests in the home. Due to repeated usage, the litter box can become stained and scratched. The litter box also requires regular care and cleaning daily or every few days. Disposable litter boxes are expensive to use and a check is required by the owner to change the litter boxes on a regular basis. Further, the dirty litter box may cause diseases such as urinary tract diseases (UTI), bladder inflammation, kidney blockage and failure since the cat regularly “holds it in” from not wanting to use a dirty litter box. The cleaning up of the litter box is a mundane chore that normally needs to do be done every day by the pet owner. Also, litter box odor is stressful for cats, and embarrassing for pet owners. Conventional cat litter boxes are unable to effectively control odors due to the type of litter used and lack of a lid and enclosure.

Additionally, conventional cat litter box products oftentimes fail to satisfy the user's wants and needs. More specifically, people may want a cat litter box that is attractive, accepted and used by a cat, has an adjustable opening sized only for cats to pass through such that dogs, and other pets cannot get into the box, offers privacy to the cat and reduces litter mess around the room.

The cat bathroom box product should ensure that foul odors remain or are trapped within the litter box until the litter box is cleaned and sanitized. Accordingly, there is a need for an improved cat litter box product along with an enclosure or a box in rectangular or square shape and that is attractive, hygienic for both cats and people, private for the cat and that contains a window ventilation system.

Therefore, there exists a long felt need in the art for a cat bathroom that has an adjustable opening, sized only for cats to pass through and preventing dogs and other household pets from inadvertently accessing the litter box. There is also a long felt need in the art for an improved cat bathroom with a litter box that offers privacy to a cat while maintaining proper light and ventilation to keep the cat comfortable while using the bathroom. Additionally, there is a long felt need in the art for a cat bathroom that ensures foul odors remain within the box until the litter box is cleaned, serviced and sanitized. Finally, there is a long felt need in the art for a cat bathroom which is a more aesthetic and attractive option to hiding a litter box in a home.

The subject matter disclosed and claimed herein, in one embodiment thereof, comprises a litter box within a generally rectangular or square box-style enclosure having a window on one or more walls of the box to provide a ventilation system, a lid to ensure that foul odors remain within the generally rectangular or square box until the litter box is cleaned and sanitized and an adjustable opening, sized only for cats to pass through, and preventing dogs and other household pets from inadvertently accessing the litter box. More specifically, the improved cat bathroom of the present invention provides a user with an attractive and pleasant cat bathroom with wood trim or pseudo wood lined entrance, corners and windows which increases the aesthetic value of the room while maintaining the privacy of the cat and hygiene of both cats, other pets and people. The invention also offers a more useful cat bathroom for individuals to keep within the house as the foul odors remain within the box until the litter box is cleaned and sanitized.

In this manner, the generally rectangular or square box-style cat bathroom of the present invention accomplishes all the forgoing objectives and provides a hygienic and aesthetic cat bathroom according to the wants and needs of the user. The improved cat bathroom of the present invention also provides privacy to the cat inasmuch as it offers an enclosed private space to the cat while using the cat bathroom and maintains cleanliness by eliminating the spraying out of the litter from the litter box onto the floor of the room where the cat box is placed. Finally, the improved cat bathroom of the present invention is sized and configured only for cats to pass through and prevents dogs, young children and other household pets from inadvertently accessing the litter box and making a mess.

### SUMMARY OF THE INVENTION

The following presents a simplified summary to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a generally rectangular or square box-style cat bathroom product or litter pan, with an enclosed litter box having a window on one or more walls of the box to provide a ventilation system, a lid to ensure that foul odors remain within the generally rectangular or square box until the litter box is cleaned and sanitized and an adjustable opening, sized only for cats to pass through, thereby preventing dogs and other household pets from inadvertently accessing the litter box. More specifically, the cat bathroom of the present invention allows users of the product to be used by cats, provides their pets with privacy while using the bathroom, keeps the foul odors within the box until the litter box is cleaned and sanitized and provides an aesthetic and attractive look for the pet owner.

The subject matter disclosed and claimed herein, in one embodiment thereof, comprises a generally rectangular or quadrate shaped cat bathroom box comprised of four walls, a lid, one or more window(s) on one or more of the walls of the cat bathroom box to provide a lighting and ventilation system, an adjustable opening in one or more walls of the box, sized and configured only for cats to pass through the box and a floor in the interior on which an enclosed cat litter pan is placed for the cat to use for their bathroom needs. The lid is hinged on one end with a fastener system such as hook and eye clamps and the like, to lock it in place and can be opened by utilizing a handle on the lid to take the litter pan out for cleaning and sanitizing purposes. The generally rectangular cat bathroom box may further comprise screens for scent control, wood or faux wood trim around the entrance, corners, and windows. The generally rectangular cat bathroom box may further comprise a carpet, fabric or wall paper to cover the surface of the box and a name card attached to any of the wall of the box to identify the family pet. Other signage or customization features may be added as needed allowing the pet owner to customize the cat bathroom box. In addition, the owner, for example, may attach cat toys to the cat bathroom box.

In a further embodiment of the present invention, a generally square cat bathroom box is disclosed. The square or quadrate cat bathroom box comprised of four walls of substantially similar size, connected to one another along sides, a square lid which seats on the top of the walls and may have a slight overlap or may be coterminous with the walls, one or more square window on one or more walls of the cat bathroom box to provide a ventilation system and viewing so that the owner can see when the bathroom box requires servicing, an adjustable opening in one or more walls of the box, sized only for cats to pass through the box and a base on which an enclosed cat litter box is placed for the cat to evacuate. The base is sized to be slightly smaller than the overall interior area of the bathroom box when assembled, but may also have a perimeter which meets the perimeter of the walls when assembled. The lid is hinged on one end with a fastener such as hook and eye clamps and the like, to lock it in place and can be opened by the user by using a handle on the lid to take the litter box out for cleaning and sanitizing purposes. The generally square cat bathroom box may further comprise screens for scent control, wood trim lining the entrance, corners, and windows. The generally square cat bathroom box may further comprise a carpet, fabric, wallpaper or the like to cover the surface of the box and a name card or placard attached to any of the wall of the box.

Providing a hygienic solution to problems associated with managing feline pet waste, the cat bathroom box of the present invention ensures the homeowner and pets alike of a clean and healthy environment for animals and human residents. Easy to use and durably constructed, the present invention is highly effective and functional for use in households, veterinary clinics, pet boarding facilities, pet groomers and animal shelters.

In one preferred embodiment of the presently described invention, a cat bathroom box, is described and includes four sidewalls, each sidewall having two sides, and top and bottom edges, the four sidewalls are joined to one another along the sidewalls to form an interior area. A top placed over the top edges of each of the four sidewalls, the top providing a closure to the interior area and the top at least partially removable. At least one sidewall has first and second openings, with the first opening providing an entry point for a feline and the second opening providing at least one of ventilation or illumination. A litter pan is sized and configured to fit within the interior area and for easy cleaning and removal from the interior area.

In a further exemplary embodiment of the presently described invention, the litter pan enclosure is described and includes four sidewalls, each sidewall having an equal height and two of the sidewalls having a length longer than the other two of the four sidewalls. Each of the sidewalls has at least one opening for one of entry, illumination or ventilation, and at least one of the sidewalls has a name plate or placard, with the name plate or placard disposed adjacent to an opening. The four sidewalls forming an interior area and each of the sidewalls are joined to one another along sides, each of the four sidewalls has a top and bottom edge. A lid disposed on the top edge of each of the four sidewalls, the lid being removable from the sidewalls. At least one of the sidewalls has first and second openings with the first opening for egress and the second opening for illumination. The first opening sized and configured for a feline. A litter removal carpet or paper disposed in the interior area and a litter pan covering at least part of the interior area.

In a still further exemplary embodiment of the presently described invention, a feline litter pan enclosure is described and includes a rectangular box having four sidewalls, a lid and a base, with the lid being coterminous with the tops of the sidewalls. At least one of the sidewalls has a first and second openings, with the first opening being for egress and the second opening for one of illumination or ventilation. The sidewalls, lid and base define an interior area. A name plate or placard is disposed on at least one of the sidewalls. A carpet is disposed in the interior area. A litter pan is disposed in the interior area and covers at least part of the carpet. A handle is attached to the lid and the lid is hingedly connected to one of the four sidewalls other than the sidewall having the first and second openings.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of generally square, rectangular or quadrate shaped cat bathroom box of the present invention with an open lid condition in accordance with the disclosed structure;

FIG. 2 illustrates a perspective view of a cat entering the generally rectangular, square or quadrate shaped cat bathroom box of the present invention with a closed lid condition in accordance with the disclosed structure;

FIG. 3 illustrates a perspective side view of the rectangular, square or quadrate shaped cat bathroom box from a sidewall to which the lid is hinged in accordance with the disclosed structure;

FIG. 4 illustrates an perspective view of a window present in the front wall of the cat bathroom box of the present invention in accordance with the disclosed structure; and

FIG. 5 illustrates a perspective interior view of the cat bathroom box of the present invention in accordance with the disclosed structure.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof.

As noted above, there exists in the art a long felt need for an improved cat bathroom furniture that has an adjustable opening, sized only for cats to pass through and preventing dogs and other household pets, as well as small children or infants from inadvertently accessing the litter box. There is also a long felt need in the art for an improved cat bathroom with a litter box that offers privacy to a cat while maintaining proper light and ventilation to keep the pet comfortable while using the bathroom. Additionally, there is a long felt need in the art for a cat bathroom that ensures foul odors remain within the box until the litter box is cleaned and sanitized. Finally, there is a long felt need in the art for a cat bathroom which is a more aesthetically pleasing and attractive option to hide, disguise or conceal a litter box in a home.

The innovative product of the present invention features a litter box within a generally rectangular, quadrate or square shaped box-style enclosure having a window on one or more walls of the box to provide a ventilation system and visibility, a lid to ensure that foul odors remain within the generally rectangular, quadrate or square shaped box until the litter box is cleaned and sanitized and an adjustable opening, sized only for cats to pass through, and preventing dogs and other household pets from inadvertently accessing the litter box. More specifically, the improved cat bathroom of the present invention provides a user with an attractive and pleasant cat bathroom with a wood trim lined entrance, corners and windows, which increases the aesthetic value of the room while maintaining the privacy of the cat and hygiene of both the cat and people. The invention also offers a more useful cat bathroom for individuals to keep within the house, as the foul odors remain within the box until the litter box is cleaned and sanitized.

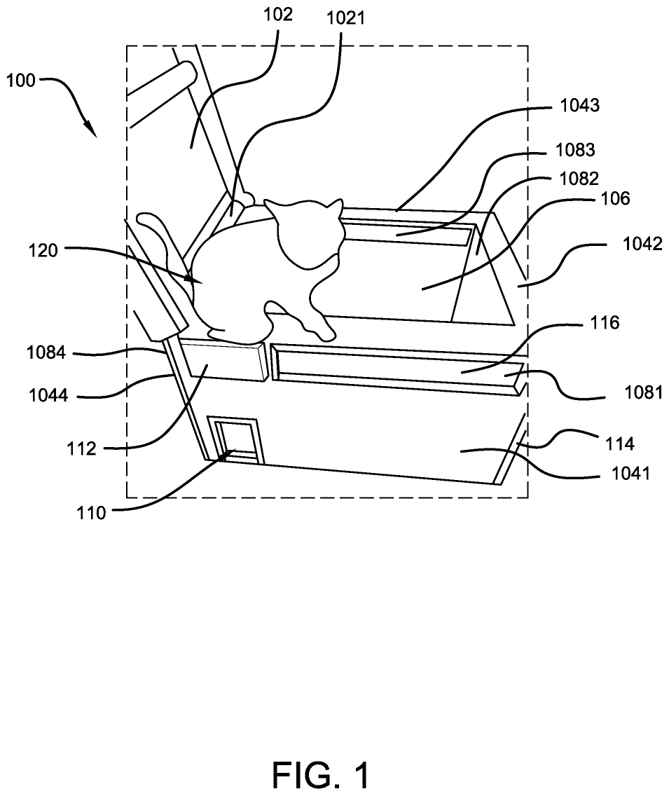

Referring initially to the drawings, FIG. 1 illustrates a perspective view of generally rectangular cat bathroom box 100. The box 100 has a horizontal bottom wall (not shown), and sidewalls 1041, 1042, 1043 and 1044 extending substantially perpendicularly therefrom. Each of the sidewalls are joined to one another along their sides to form the enclosure. The sidewalls may be secured by adhesive, nails, tacks or have a tongue and groove assembly for easy construction at home. The sidewalls form an area and the base of the sidewalls once constructed create a perimeter which defines the area. A lid 102 rests on the top edges of the sidewalls 1041, 1042, 1043 and 1044 and is hinged at one end 1021 to an edge of a sidewall 1044 and may be fastened using a fastener known in the art such as hook and eye clamps, magnetic fastener and the like to lock the lid 102 in place and close the box 100 from top. The edges of the lid may be coterminous with the edges of the sidewalls, may extend beyond the edges of the sidewalls or may envelop the tops of the side walls to create a different aesthetic appearance. A plurality of latches may be used to secure the lid 102 in a closed position and a handle or a knob is present on the lid to provide convenience to users in operating the lid 102. An adjustable opening 110, preferably but not limited to square or rectangular shape is present on one of the bottom corners of the sidewall 1041. The dimensions of the opening 110 are designed to allow cats to enter and exit, while preventing dogs and other animals to enter in the box 100. The opening may be any other shape such as circular, ovoid, elliptical, star, trapezoid, triangle or other geometric shape. Alternatively, the opening could be in the shape of a letter, such as the beginning letter of the name of the cat, or take the appearance of a cat or other shape depending on the preference of the pet owner in creating a customized cat bathroom.

The corner positioning of the opening 110 may further aid in prohibiting unwanted animals such as dogs, or small children or infants from accessing the interior area 106 of the cat bathroom 100. One or more windows 1081, 1082, 1083 and 1084 are present on the sidewalls 1041, 1042, 1043 and 1044 respectively to maintain proper light and ventilation in the interior region or area 106 of the box 100. The windows may be of any geometric shape or other design known in the art and depending on the preferences of the pet owner. The windows 1081, 1082, 1083 and 1084 are lined with meshed screens 116 for scent control, ventilation, and visual appeal. By customizing the shape of the windows as well as the opening 110 of the cat bathroom box, the pet owner can create any theme or arrangement that the cat owner desires. To give a personal appearance and identify the cat bathroom box 100, a name card or placard 112 may be pasted or fixed to one of the walls using adhesive or any other fastener such as the Velcro® and the like. The dimensions of the box 100 are such that a litter pan or box (not shown) of an appropriate size and shape may be easily placed on the horizontal bottom wall of the box 100 and the cat 120 easily moves within the interior space 106 without colliding with the sidewalls 1041, 1042, 1043 and 1044. The litter pan is generally smaller than the interior space 106 to allow easy removal of the litter pan for cleaning when needed.

The lid 102 of the rectangular cat bathroom box 100 allows the user to remove the litter tray or pan from the box 100 for easy cleaning, replacement and sanitization and to clean the interior 106 of the box 100. In an embodiment, to ensure the safety of the cats, the height of the sidewalls is dimensioned such that it makes the lid 102 difficult to get to by the cats 120. In alternative embodiment, the lid 102 may not be hinged to any sidewall and may be completely removed from the top portion of the box 100. The lid, if not hingedly attached to the box, needs to be of a sufficient weight such that the cat cannot inadvertently push it open, thereby defeating the purpose of having an opening only sized for the cat to enter. In one embodiment, the lid 102 is hingedly connected to one of the four sidewalls 1041, 1042, 1043 and 1044, other than the sidewall having the first and second openings as the same may be structurally weaker than the sidewalls without such openings.

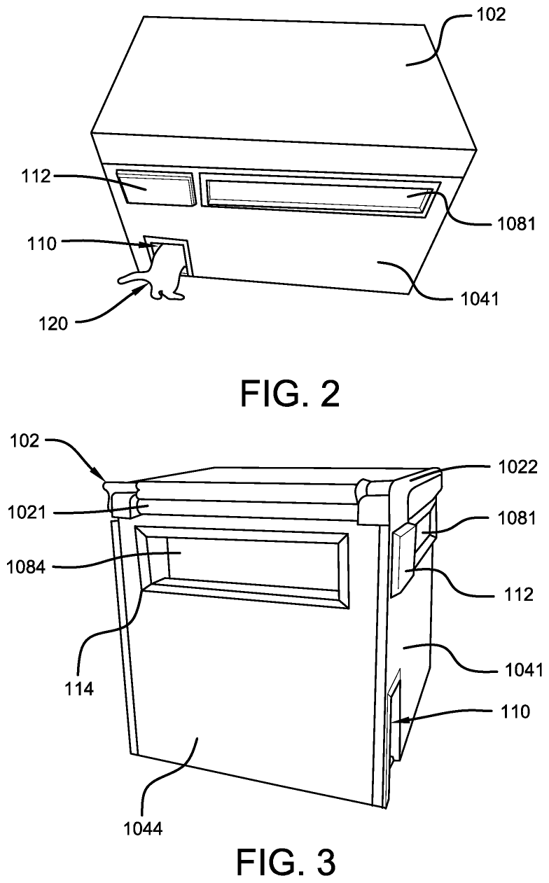

FIG. 2 illustrates a perspective view of a cat entering the generally rectangular, quadrate or square cat bathroom box of the present invention in a closed lid configuration in accordance with the disclosed structure. A cat 120 enters the box 100 through the adjustable opening 110 which is sized and configured for the domesticated cats present in the sidewall 1041. An adult domesticated cat averages about 46 cm (18 in) in head-to-body length and 23-25 cm (9-10 in) in height, with about 30 cm (12 in) long tails. Males are larger than females. Adult domestic cats typically weigh between 4 and 5 kg (9 and 11 lbs). Kittens are much smaller than adult domesticated cats, and the opening can be enlarged as the cat grows to adulthood. Other domesticated animals such as dogs or even small or young children cannot enter the box 100 due to the size limitation and thus the product of the present invention offers a private, secure space for the cat 120.

FIG. 3 illustrates a perspective side view of the rectangular cat bathroom box 100 from the sidewall 1044 to which the lid 102 is hinged. Hinged fastener 1021 attaches the lid 102 to the sidewall 1044 and allows the lid 102 to open and close as desired. A window 1084 is cut into an upper portion of the sidewall 1044 for proper lighting and ventilation for the cat 120 during evacuation of waste material. The window 1084 may be cut or designed on any position on the sidewall 1044 and in any shape as desired by the user. Also, as described earlier, the front wall 1041 has a personalized name card or placard 112, a window 1081 and an adjustable opening 110. The window 1084 (and windows 1081, 1082, 1083 on the other sidewalls) has a wooden trim or covering 114 for strength and visual appeal. Like the windows, the edges of the sidewalls may also have the wooden trim or any other type of trim that may be pleasing to the owner, e.g. rope, fabric, fringe, etc.

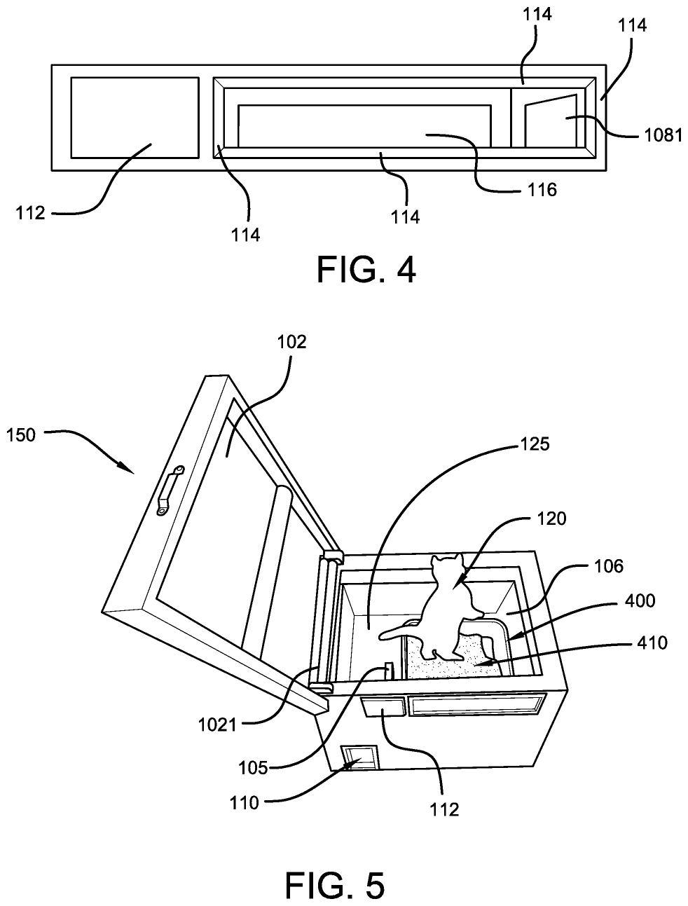

FIG. 4 illustrates a perspective view of the window 1081 in the front wall 1041 of the box 100. The window 1081 in this embodiment is rectangular in shape and has a window trim 114 on a boundary of the window 1081 for attractive appearance and to delineate the window from the remainder of the wall. The window 1081 has a mesh screen 116 to prevent dust and provide adequate lighting and ventilation to the cat 120 during excretion in the litter box 100. Other materials may be used in lieu of screening such as fabric or if the window is for light only, then a plastic film or polyethylene material may be used if other windows have a screen of fabric for ventilation. In this way, at least one of the windows can be for illumination only, while others may be for both illumination and ventilation. The window 1081 may be of any desirable size and shape.

FIG. 5 depicts a perspective interior view of the cat bathroom box 100. A cat litter box or pan 400 is placed on the floor of the box 100. The litter box or pan 400 may be of any shape and size as desired by use to fit within the box 100. The cat litter box 400 has a base integrally molded to surrounding walls that retain the filler 410 within the litter box 400. Once the cat 120 enters the cat bathroom 100 through the opening 110, the cat steps into the litter box 400 to relieve themselves of waste. The cat has its own safe spot and privacy for potty time and feels safe in the process of excretion the waste. The litter box is filled with a loose granular material 410 that absorbs the moisture and odor. The outside of litter tray 400 is made of durable Nylon fabric, while the inside is made of waterproof PEVA and reinforced with a seamless waterproof liner to avoid leaking within the bathroom box 100. Once relieved, the cat leaves the bathroom box 100 through the opening 110. In doing this, the cat's paws contact the relatively rough carpet 125 present on the floor of the bathroom box 100 which tends to cause any litter particles to fall within the box 100, facilitates paw cleaning and reduce the litter mess in the room. The carpet may be constructed of plastic fibers like AstroTurf® or a slightly tacky paper to collect the litter. If the lid 102 is open, the cat may leap out over the sidewalls to exit the bathroom box 100. The litter box 400 is cleaned and sanitized either by taking the litter pan 400 out of the box 100 or within the box 100 when the lid 102 is open. Thus, the cat bathroom box 100 hides the litter box 400 and increases the aesthetic value of the room in which the box 100 is kept.

In an alternative embodiment, the cat bathroom box 100 may be square in shape and structure with all the sidewalls are of same dimensions. The height of the walls should be 12 inches or more so that it is taller than the average domesticated cat. The walls of the box 100 should be more than 20 inches to allow the cat to move around easily or if a rectangular the long walls would be 20 to 24 inches long and the short walls perhaps 18 to 20 inches. The square, rectangular or quadrate cat bathroom box 100 gives an aesthetic and a symmetric value to the box 100.

In general, the invention described herein relates to a cat bathroom designed to allow cats to enter and exit, while preventing dogs and other animals from accessing the filler 410 and waste therein. The cat bathroom 100 is preferably, but not necessarily, rectangular or square in shape. Alternate embodiments may be circular, or any suitable geometric shape wherein filler may be retained within.

The cat bathroom box 100 may be composed of any material suitable for the uses of animal housing. For instance, cat bathroom box 100 may include wood, particle board, laminate, mesh, wire, plastic, metal, and the like. In addition, the outer surface of the sidewalls of the box 100 may comprise any suitable covering for use with animals. For instance, the outer surface of the sidewalls may be composed of natural or synthetic woods, veneers, vinyl, a weaving, plastic, ceramic, and the like. The weaving may include wicker, vinyl, and any other weavable material suitable for use with cat bathroom box 100. In an embodiment, at least the cat bathroom box 100 may be made of an antimicrobial or antibacterial material such, such as plastic embedded with silver particles, or likewise agents as known in the antibacterial/antimicrobial arts. Alternatively, areas of the box 100 may be coated with an antimicrobial material. Further, the box 100 may be available in multiple color options, either through painting or application of fabric which matches the decor of the room or space in which the box 100 is kept.

In accordance with the present invention, windows 1081, 1082, 1083 and 1084 and opening 110 in side walls 1041, 1042, 1043 and 1044 may have any shape, configuration, and size suitable for allowing ventilation and visibility into and out of the cat bathroom 100. For instance, such openings may have the shape of characters such as animals, cartoon figures, lettering, numbering, symbols, and the like. Without limitation, examples of animal shapes include cats, and the like. In addition, without limitation, examples of cartoon figures include MICKEY MOUSE (which is a mark owned by Disney Enterprises, Inc.) and the like. The character shape openings may be applied to the sides by any suitable process such as by a cutting apparatus, press, or the like.

The opening 110 of the cat bathroom box 100 of the present invention may have any basic shape provided that the opening 110 permits the entrance of cats and restricts the access of dogs and other animals that may feed on the contents therein. It is desirable that the box 100 and sidewalls 1041, 1042, 1043 and 1044 are impermeable, odor resistant, and mold resistant. The lid 102 is constructed of a sufficiently rigid material. In all embodiments of the present invention, the lid 102 is removable to facilitate cleaning of the litter box 400. Additionally, as best shown in FIG. 5, a partition 105 may extend into the interior space 106 from sidewall 1041 adjacent to opening 110 to prevent another animal from peering or reaching into interior space 106, thereby increasing the cat's privacy and safety while inside of the cat bathroom box 100.

Certain terms are used throughout the following description and claims to refer to features or components. As one skilled in the art will appreciate, different persons may refer to the same feature or component by different names. This document does not intend to distinguish between components or features that differ in name but not structure or function. As used herein “cat bathroom”, “cat bathroom box”, “bathroom box” and “box” are interchangeable and refer to the cat bathroom box 100 of the present invention. As used herein “litter box” refers to indoor solid and liquid waste collection boxes that are commonly used by cats. As used herein “litter box” and “litter tray” are used interchangeably.

Notwithstanding the forgoing, the cat bathroom box 100 of the present invention can be of any suitable size and configuration as is known in the art without affecting the overall concept of the invention, provided that it accomplishes the above stated objectives. One of ordinary skill in the art will appreciate that the size, shape and material of the cat bathroom box 100 as shown in the FIGS. are for illustrative purposes only, and that many other sizes of the cat bathroom box 100 are well within the scope of the present disclosure. Although the dimensions of the cat bathroom box 100 are important design parameters for user convenience, the cat bathroom box 100 may be of any size that ensures optimal performance during use and/or that suits user need and/or preference. It is contemplated that the cat bathroom box 100 may have either square or rectangular shape sidewalls thereon, and of varying dimensions, thereby allowing the user to choose which configuration and size to choose for an application. The possibilities are endless.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A litter box comprising;
four sidewalls, wherein each of said four sidewalls is comprised of two sides, a top edge and a bottom edge, and further wherein the four sidewalls are joined to form an interior area;
a top placed over the top edges of each of the four sidewalls, the top providing a closure to the interior area wherein the top is at least partially removable from the four sidewalls; and
a litter pan sized and configured to removably fit within the interior area, wherein at least one of the four sidewalls is comprised of a first opening and a second opening.

2. The litter box of claim 1, wherein the four sidewalls have a height of more than 12 inches and at least two of the four sidewalls have a length of more than 18 inches.

3. The litter box of claim 1, wherein each of the four sidewalls are provided with at least one opening.

4. The litter box of claim 1, wherein the second opening is removably covered with a plastic or polyethylene cover.

5. The litter box of claim 1, wherein the second opening is removably covered with a breathable fabric or mesh material to provide ventilation.

6. The litter box of claim 1, wherein the top is comprised of a plurality of edges that are coterminous with the top edges of each of the four sidewalls.

7. The litter box of claim 1 further comprising a hinge, wherein the hinge is attached to the top and at least one of the four sidewalls.

8. The litter box of claim 1, wherein the top is further comprised of a handle for repositioning of the top relative to the interior area.

9. The litter box of claim 1, wherein the top has a surface area which is larger than the interior area such that the top extends outwardly beyond at least one of the four sidewalls.

10. The litter box of claim 1 further comprising a placard on at least one of the four sidewalls.

11. The litter box of claim 1, wherein each of the four sidewalls is comprised of a window.

12. The litter box of claim 11, wherein at least one of the windows is comprised of a shape that is different from the remaining windows.

13. The litter box of claim 11, wherein at least one of the windows is repositionable.

14. The litter box of claim 1, wherein the interior area is provided with one of a carpet or a tacky sheet material.

15. The litter box of claim 1, wherein each of the four sidewalls has an exterior surface and the exterior surface is covered with one of a fabric, a carpet or a wallpaper.

16. A litter box enclosure comprising:
a plurality of sidewalls, wherein each of the sidewalls have an equal height and two of the sidewalls have a length that is longer than the remaining plurality of sidewalls, wherein each of the plurality of sidewalls has at least one opening therein, and further wherein at least one of the plurality of sidewalls has a placard disposed thereon adjacent to the at least one opening;
the plurality of sidewalls forming an interior area and each of the plurality of sidewalls are comprised of a top edge and a bottom edge;
a lid disposed on the top edge of each of the plurality of sidewalls, the lid being removable from the plurality of sidewalls;
at least one of the plurality of sidewalls having a second opening configured to accommodate a feline passing therethrough; and
a litter removal carpet or paper disposed in the interior area and a litter pan covering at least a portion of the interior area.

17. The litter box enclosure of claim 16, wherein each of the plurality of sidewalls has an exterior surface covered with one of a fabric, a carpet or a wallpaper.

18. The litter box enclosure of claim 16, wherein the height of the plurality of sidewalls is more than 12 inches, and the length of at least two of the plurality of sidewalls is more than 18 inches.

19. The litter box enclosure of claim 16, wherein each of the openings has a different shape.

20. A feline litter pan enclosure comprising;
a rectangular box having four sidewalls, a lid and a base, with the lid being coterminous with a top of each of the four sidewalls, wherein the four sidewalls, the lid and the base define an interior area;
at least one of the four sidewalls having a first opening and a second opening;
a placard disposed on at least one of the four sidewalls;
a carpet disposed in the interior area;
a litter pan disposed in the interior area, and covering at least part of the carpet; and
a handle attached to the lid, wherein the lid is hingedly connected to one of the four sidewalls other than the sidewall having the first and second openings.
